(19) United States
(12) Patent Application Publication
(10) Pub. No.: US 2012/0075745 A1
(43) Pub. Date: Mar. 29, 2012

(54) SEALING A CORNER FILTER

(76) Inventors: Ryan Thomas Davis, Mountain View, CA (US); Ricardo German Duque, Dublin, CA (US); Ferdinand Hendriks, Morgan Hill, CA (US); Jr-Yi Shen, Sunnyvale, CA (US)

(21) Appl. No.: 12/892,716

(22) Filed: Sep. 28, 2010

(51) Int. Cl. G11B 33/14; B23P 11/00

(52) U.S. Cl. 360/97.02; 29/428; G9B/33.035

(57) ABSTRACT

A hard disk drive includes a base plate, a cover mounted to the base plate and a corner filter disposed proximate to a corner of the hard disk drive. A corner filter seal disposed between the base plate and the cover. The corner filter seal is configured to prevent leakage of filter air flow through a clearance between the base plate and the cover. The clearance is at least laterally proximate the corner filter.

### BACKGROUND

Hard disk drives typically include filters that collect contaminants within the hard disk drive. As a magnetic disk rotates within the hard disk drive, it creates air flow that can flow through a particle filter. The flow rate, Q, through a particle filter is proportional to the pressure difference, ΔP, between each side of the particle filter. Accordingly, as the pressure difference increases, the flow rate also increases. As a result, more particles will be trapped per unit time when the flow rate Q is large. In contrast, fewer particles will be trapped per unit time if the pressure difference decreases. For example, the pressure difference decreases if air flows around the filter rather than through the filter.

### BRIEF DESCRIPTION OF THE DRAWINGS

FIG. 1 illustrates an example of a HDD, in accordance with an embodiment of the present invention.

FIGS. 2A-D illustrates examples of a corner filter seal, in accordance with embodiments of the present invention.

FIG. 3 illustrates an example of a flow chart of a method for sealing a corner filter seal, in accordance with an embodiment of the present invention.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

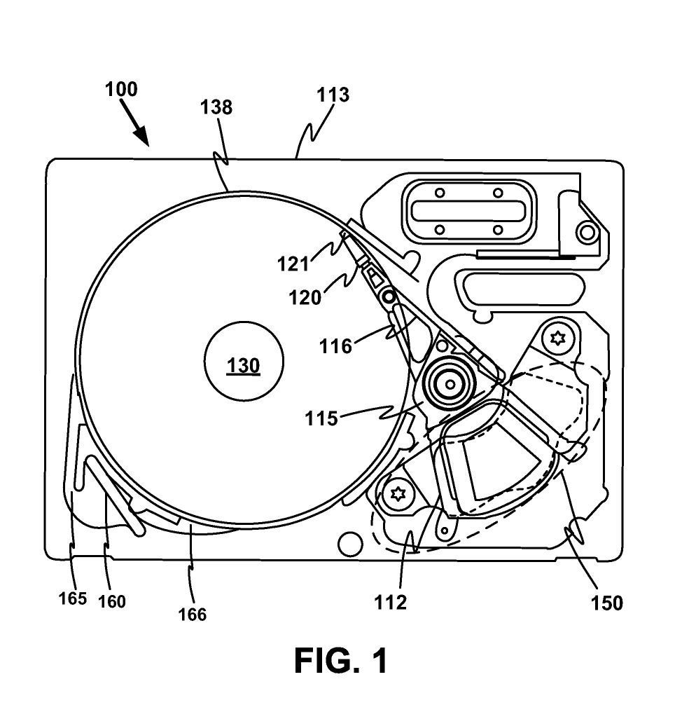

With reference now to FIG. 1, a schematic drawing of one embodiment of an information storage system including a magnetic hard disk file or HDD 100 for a computer system is shown, although only one head and one disk surface combination are shown. What is described herein for one head-disk combination is also applicable to multiple head-disk combinations. In other words, the present technology is independent of the number of head-disk combinations.

In general, HDD 100 has an internal base plate 113 and an internal cover (not shown). In one embodiment, internal housing 113 contains a disk pack having at least one media or magnetic disk 138. The disk pack (as represented by disk 138) defines an axis of rotation and a radial direction relative to the axis in which the disk pack is rotatable.

A spindle motor assembly having a central drive hub 130 operates as the axis and rotates the disk 138 or disks of the disk pack in the circumferential direction relative to internal base plate 113. An actuator assembly 115 includes one or more actuator arms 116. When a number of actuator arms 116 are present, they are usually represented in the form of a comb that is movably or pivotally mounted to base/housing 113. A controller 150 is also mounted to internal base plate 113 for selectively moving the actuator arms 116 relative to the disk 138. Actuator assembly 115 may be coupled with a connector assembly, such as a flex cable to convey data between arm electronics and a host system, such as a computer, wherein HDD 100 resides.

In one embodiment, each actuator arm 116 has extending from it at least one cantilevered integrated lead suspension (ILS) 120. The ILS 120 may be any form of lead suspension that can be used in a data access storage device. The level of integration containing the slider 121, ILS 120, and read/write head is called the Head Gimbal Assembly (HGA).

The ILS 120 has a spring-like quality, which biases or presses the air-bearing surface of slider 121 against disk 138 to cause slider 121 to fly at a precise distance from disk 138. ILS 120 has a hinge area that provides for the spring-like quality, and a flexing cable-type interconnect that supports read and write traces and electrical connections through the hinge area. A voice coil 112, free to move within a conventional voice coil motor magnet assembly is also mounted to actuator arms 116 opposite the head gimbal assemblies. Movement of the actuator assembly 115 by controller 150 causes the head gimbal assembly to move along radial arcs across tracks on the surface of disk 138.

HDD 100 includes a corner filter 160 configured to filter contaminants within HDD 100. For example, an air flow is generated as disk 138 rotates during operation of HDD 100. The air flow travels through inlet channel 165 and through corner filter 160. After passing through corner filter 160, the air flow exits outlet channel 166, which will be described in detail below.

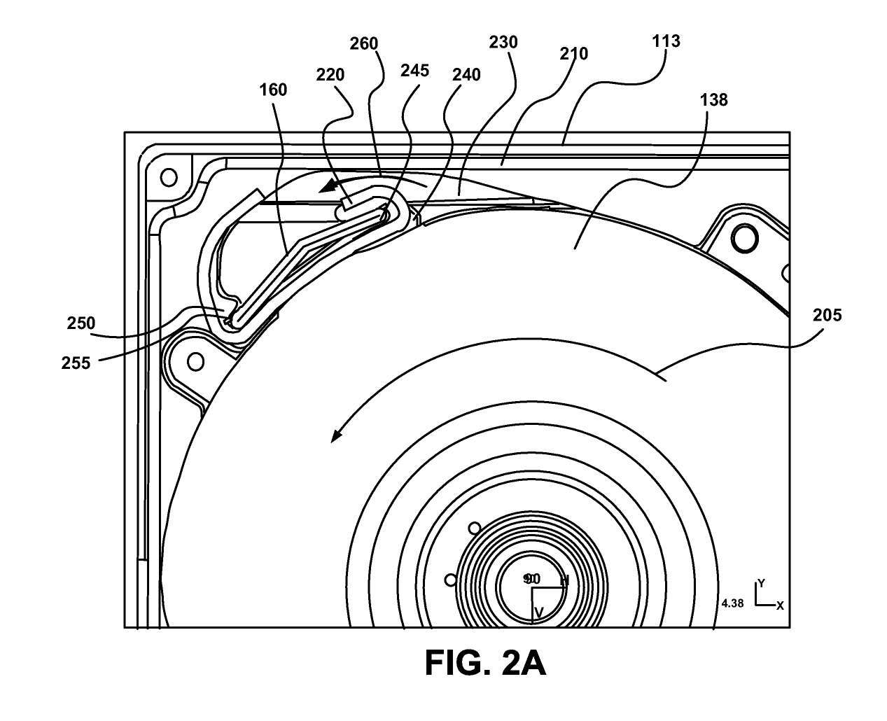

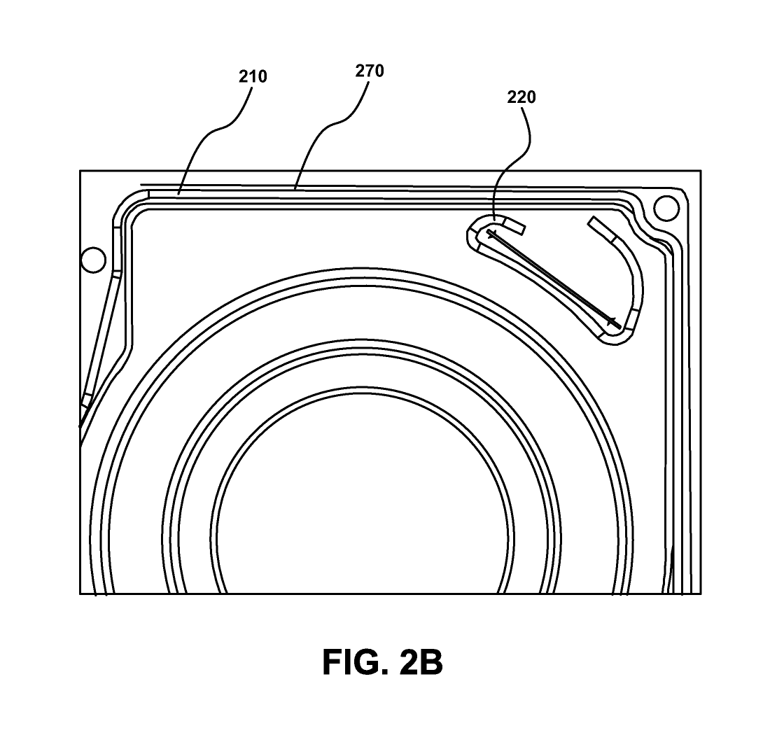

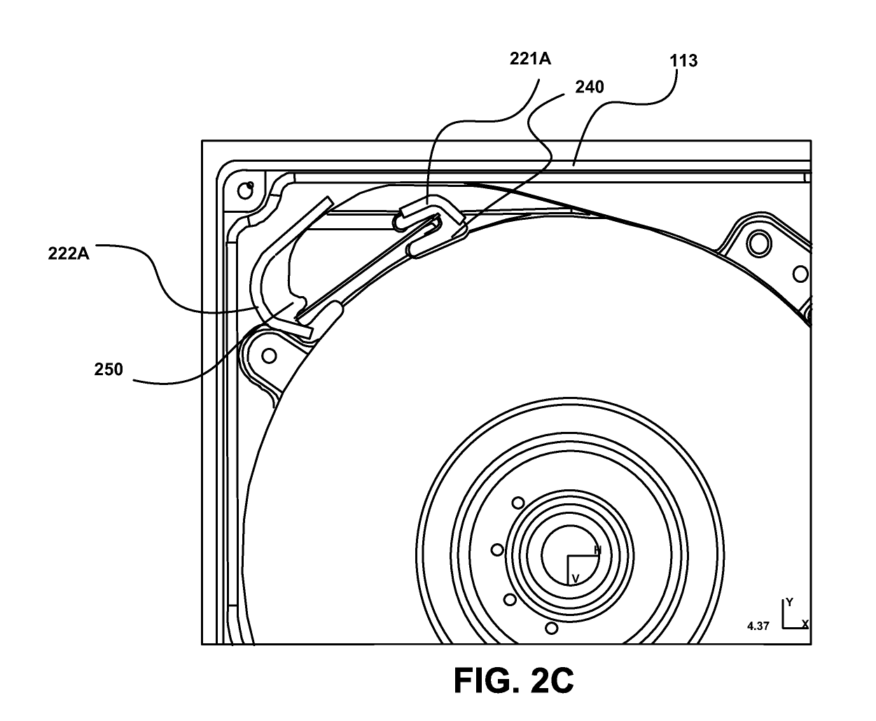

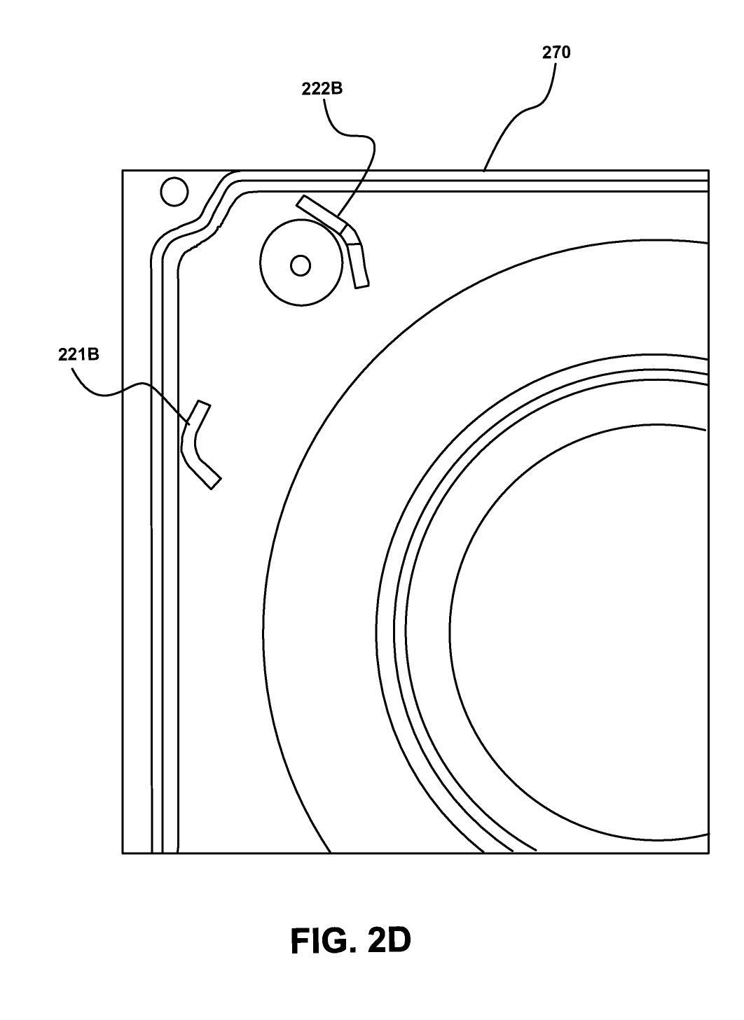

FIG. 2A depicts a base plate 113 of HDD 100, in accordance with an embodiment of the present invention. Base plate 113 includes disk 138, hermetic seal 210, corner filter 160, corner filter seal 220, corner channel 230, first boss 240, first slot 245, second boss 250 and second slot 255. For purposes of clarity, a cover (e.g., cover 270 of FIG. 2B) is not shown in FIG. 2A. as well as FIG. 2C, which is described in detail below.

As disk 138 spins in direction 205, during operation of HDD 100, disk 138 generates air flow within HDD 100. In particular, filter air flow 260 travels through corner channel 230 and eventually through corner filter 160.

Corner filter 160 is configured to filter contaminants within filter air flow 260. Corner filter 160 is also referred to as an “11 o'clock filter” due to its position to disk 138 within the corner of HDD 100. Corner filter 160 can be any flow through filter that is compatible with filtering contaminants within a hard disk drive.

Corner filter 160 is disposed within the corner channel between base plate 113 and a cover (e.g. cover 270 of FIG. 2B). Corner filter 160 is held in place within HDD 100 by inserting one distal end into slot 245 of boss 240 and the opposite distal end into slot 255 of boss 250. Boss 240 and boss 250 are protrusions on base plate 113. In various embodiments, a bottom edge of corner filter 160 physically contacts base plate 113 and a top edge of corner filter 160 physically contacts the cover.

As described above, a particle filter (e.g., corner filter 160) has a flow rate of:

Q=kΔPA, (equation 1)

where factor k is related to the construction of the filter (e.g., weave, electrical charge, etc.), ΔP is the pressure difference between the two sides of the filter and A is the area of the filter.

Accordingly, the larger ΔP for corner filter 160 the larger the flow rate Q through corner filter 160. As a result, the higher Q, the more contaminants (e.g., particles, unwanted chemical vapor, etc.) that are filtered by corner filter 160.

Corner filter seal 220 is configured to prevent filter air flow 260 from flowing around corner filter 160 and thereby increasing ΔP. Corner filter seal 220 is disposed between base plate 113 and a cover. In various embodiments, corner filter seal 220 is disposed on bosses 240 and 250 and also along parts of the periphery of corner channel 230.

As a result, corner filter seal 220 prevents leakage of filter air flow 260 through a clearance between base plate 113 and a cover. In particular, corner filter seal 220 prevents leakage of filter air flow 260 at least at a clearance proximate the lateral sides of corner filter 160. In another embodiment, corner filter seal 220 prevents leakage between a top portion of corner filter 160 and a cover.

In contrast, in conventional hard disk drives, a clearance between base plate 113 and a cover allows air flow to pass around a corner filter. In particular, there is at least a clearance proximate the lateral sides of the corner seal. Thus, ΔP decreases and fewer contaminants are filtered through the corner filter.

In one embodiment, corner filter seal 220 is a form-in-place gasket (FIPG). As depicted in FIG. 2A, corner filter seal 220 is attached to base plate 113.

FIG. 2B depicts a cover 270, in accordance with an embodiment of the present invention. Cover 270 includes corner filter seal 220 (rather than corner base plate 113 including corner filter seal 220 as depicted in FIG. 2A). Corner filter seal 220 is configured and operates, as described above, when attached to cover 270.

Cover 270 correspondingly mates with base plate 113. Hermetic seal 210 is disposed between cover 270 and base plate 113. Therefore, internal components are hermetically sealed within HDD 100.

FIG. 2C depicts base plate 113 that includes first corner seal 221A and second corner seal 222A, in accordance with an embodiment of the present invention. Rather than a single corner filter seal 220 (as depicted in FIGS. 2A-B), FIG. 2C depicts two separate corner filter seals 221A and 222A. First corner seal 221A and second corner seal 222A are configured and function similarly to corner seal 220, as described above.

First corner filter seal 221A is disposed on first boss 240 and second corner seal 222A is disposed on second boss 250. First boss 240 is upstream from second boss 250. Accordingly, first corner filter seal 221A is upstream from second corner seal 222A.

As depicted, first corner filter seal 221A and second corner filter seal 222A are attached to base plate 113. In various embodiments, one or both of first corner filter seal 221A and second corner filter seal 222A are attached to one or both of base plate 113 and cover (e.g., cover 270).

FIG. 2D depicts cover 270 that includes a first corner seal 221A and a second corner seal 222A, in accordance with an embodiment of the present invention. First corner seal 221B and second corner seal 222B are configured and function similarly to corner seal 220, and first corner seal 221A and second corner seal 22A, as described above. Moreover, it is to be understood that corner seals depicted in FIGS. 2C-D have a higher part count than the corner seals depicted in FIGS. 2A-B.

As depicted, first corner filter seal 221B and second corner filter seal 222B are attached to cover 270. In various embodiments, one or both of first corner filter seal 221B and second corner filter seal 222B are attached to one or both of cover 270 and base plate 113.

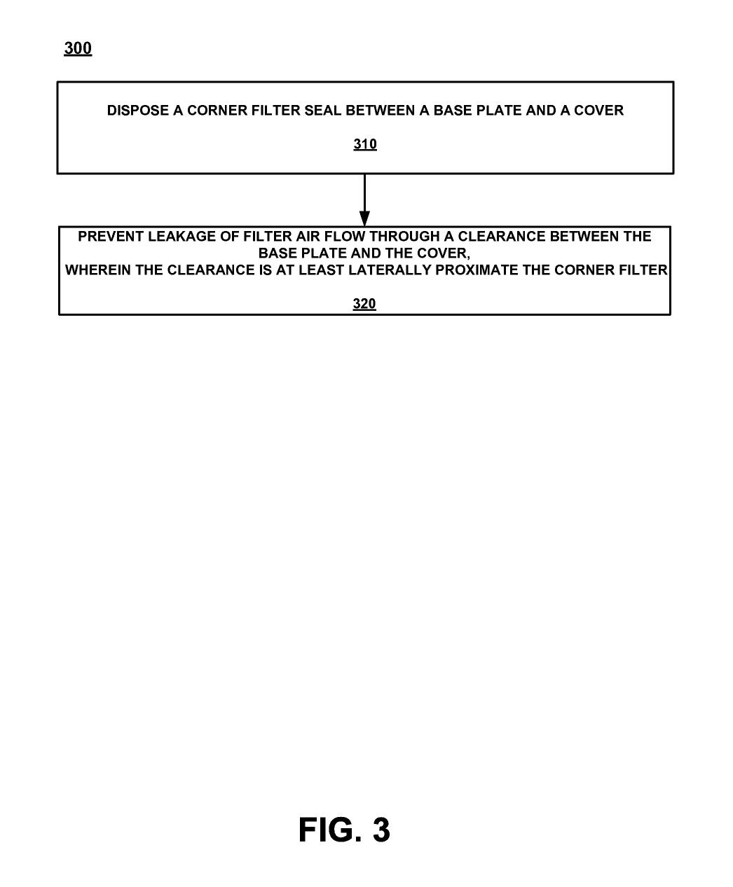

FIG. 3 depicts a method 300 for sealing a corner filter, in accordance to an embodiment of the present invention. At 310 of method 300, a corner filter seal is disposed between a base plate and a cover. For example, a corner filter 220 is disposed between base plate 113 and cover 270.

At 320 of method 300, leakage of filter air flow through a clearance between the base plate and the cover is prevented. The clearance is at least laterally proximate the corner filter. For example, leakage of filter air flow 260 through a clearance between base plate 113 and cover 270 is prevented, wherein the clearance is at least laterally proximate the cover filter

Various embodiments of the present invention are thus described. While the present invention has been described in particular embodiments, it should be appreciated that the present invention should not be construed as limited by such embodiments, but rather construed according to the following claims.

1. A hard disk drive comprising:
a base plate;
a cover mounted to said base plate;
a corner filter disposed proximate to a corner of said hard disk drive; and
a corner filter seal disposed between said base plate and said cover, wherein said corner filter seal is configured to prevent leakage of filter air flow through a clearance between said base plate and said cover, wherein said clearance is at least laterally proximate said corner filter.

2. The hard disk drive of claim 1, wherein said corner filter seal is attached to said base plate.

3. The hard disk drive of claim 1, wherein said corner filter seal is attached to said cover.

4. The hard disk drive of claim 1, wherein said corner filter seal comprises:
a first corner filter seal and a second corner filter seal.

5. The hard disk drive of claim 4, wherein said second corner filter seal is disposed downstream from said first corner filter seal.

6. The hard disk drive of claim 1, wherein said base plate comprises:
a first corner boss comprising a first slot; and
a second corner boss comprising a second slot, wherein said corner filter is disposed within said first slot and said second slot.

7. The hard disk drive of claim 1, wherein said corner filter seal is disposed on a first corner boss and a second corner boss.

8. The hard disk drive of claim 4, wherein said first corner filter seal is disposed on a first boss and a second corner filter seal is disposed on a second boss.

9. The disk drive of claim 1, wherein said corner filter seal comprises:
form-in-place gasket (FIPG).

10. A method for sealing a corner filter, said method comprising:
disposing a corner filter seal between a base plate and a cover; and
preventing leakage of filter air flow through a clearance between said base plate and said cover, wherein said clearance is at least laterally proximate said corner filter.

11. The method of claim 10, wherein said disposing a corner seal comprises:
disposing a corner seal on a first corner boss and a second corner boss, wherein said second corner boss is downstream from said first corner boss.

12. The method of claim 10, wherein said disposing a corner seal comprises:
disposing a first corner filter seal and a second corner filter seal between said base plate and said cover.

13. The method of claim 10, wherein said disposing a corner seal comprises:
disposing a first corner filter seal on a first corner boss and disposing a second corner filter seal on a second corner boss, wherein said second corner boss is downstream from said first corner boss.

14. The method of claim 10, wherein said preventing leakage of filter air flow through a clearance between said base plate and said cover comprises:
preventing leakage between a top portion of said corner filter and said cover.
